(19) United States
(12) Patent Application Publication
(10) Pub. No.: US 2026/0127293 A1
(43) Pub. Date: May 7, 2026

(54) TECHNIQUES FOR CHRONOLOGICAL VULNERABILITY EVENT RECOGNITION

(71) Applicant: Rapid7, Inc., Boston, MA (US)

(72) Inventor: Stephen Fewer, Dublin (IE)

(21) Appl. No.: 18/940,572

(22) Filed: Nov. 7, 2024

(51) Int. Cl. G06F 21/57; G06F 21/62

(52) U.S. Cl. CPC G06F 21/577; G06F 21/6218

(57) ABSTRACT

Techniques for identifying vulnerabilities in a computing environment, including: using at least one computer hardware processor to perform: obtaining first vulnerability data for a first event from external data source(s); associating the first event with a particular vulnerability in a vulnerability dictionary using at least some of the first vulnerability data, the particular vulnerability being associated with one or more historical events; enriching the first vulnerability data with first metadata comprising one or more time-based feature values to obtain first enriched vulnerability data; generating a first set of feature values for the first event using both: the first enriched vulnerability data; and enriched vulnerability data for at least some of the one or more historical events; determining, using the first set of feature values, that a vulnerability mitigation action is to be triggered for the first event; and triggering performance of the vulnerability mitigation action for the first event.

### BACKGROUND

Modern computing environments are exposed to many cybersecurity vulnerabilities. These vulnerabilities can be identified and analyzed to determine the risk posed to computing environments and any corrective actions to be taken. Cybersecurity vulnerabilities vary in their potential impact on computing systems, may be exploited in cyber-attacks to varying degrees, and are constantly evolving and being exploited in new cyber-attacks.

Cybersecurity vulnerability identification and analysis is important in a variety of computing environments including, but not limited to, (e.g., computer infrastructure operated for one organization), public computing environments (e.g., computer infrastructure made available for use by others, for example, over the Internet or any other network, e.g., via subscription, to multiple organizations), a hybrid computing environment (a combination of publicly-accessible and private infrastructure) and/or using any other type of computing environment. Non-limiting examples of cloud computing environments include GOOGLE Cloud Platform (GCP), ORACLE Cloud Infrastructure (OCI), AMAZON Web Services (AWS), IBM Cloud, and MICROSOFT Azure.

### SUMMARY

Some embodiments provide for a method identifying vulnerabilities in a computing environment, the method including: using at least one computer hardware processor to perform: obtaining first vulnerability data for a first event from one or more external data sources; associating the first event with a particular vulnerability in a vulnerability dictionary using at least some of the first vulnerability data, the particular vulnerability being associated with one or more historical events; enriching the first vulnerability data with first metadata comprising one or more time-based feature values to obtain first enriched vulnerability data; generating a first set of feature values for the first event using both: (i) the first enriched vulnerability data; and (ii) enriched vulnerability data for at least some of the one or more historical events; determining, using the first set of feature values, that a vulnerability mitigation action is to be triggered for the first event; and triggering performance of the vulnerability mitigation action for the first event.

Some embodiments provide for a system for identifying vulnerabilities in a computing environment, the system including: at least one computer hardware processor; and at least one non-transitory computer-readable storage medium storing processor-executable instructions that, when executed by the at least one computer hardware processor, causes the at least one computer hardware processor to perform a method comprising: obtaining first vulnerability data for a first event from one or more external data sources; associating the first event with a particular vulnerability in a vulnerability dictionary using at least some of the first vulnerability data, the particular vulnerability being associated with one or more historical events; enriching the first vulnerability data with first metadata comprising one or more time-based feature values to obtain first enriched vulnerability data; generating a first set of feature values for the first event using both: (i) the first enriched vulnerability data; and (ii) enriched vulnerability data for at least some of the one or more historical events; determining, using the first set of feature values, that a vulnerability mitigation action is to be triggered for the first event; and triggering performance of the vulnerability mitigation action for the first event.

Some embodiments provide for at least one non-transitory computer-readable storage medium storing processor executable instructions that, when executed by at least one computer hardware processor, causes the at least one computer hardware processor to perform a method for identifying vulnerabilities in a computing environment, the method including: obtaining first vulnerability data for a first event from one or more external data sources; associating the first event with a particular vulnerability in a vulnerability dictionary using at least some of the first vulnerability data, the particular vulnerability being associated with one or more historical events; enriching the first vulnerability data with first metadata comprising one or more time-based feature values to obtain first enriched vulnerability data; generating a first set of feature values for the first event using both: (i) the first enriched vulnerability data; and (ii) enriched vulnerability data for at least some of the one or more historical events; determining, using the first set of feature values, that a vulnerability mitigation action is to be triggered for the first event; and triggering performance of the vulnerability mitigation action for the first event.

### BRIEF DESCRIPTION OF DRAWINGS

Various aspects and embodiments will be described with reference to the following figures. It should be appreciated that the figures are not necessarily drawn to scale. Items appearing in multiple figures are indicated by the same or a similar reference number in all the figures in which they appear.

FIG. 1 shows an illustrative environment 100 in which an information security system may operate, in accordance with some embodiments of the technology described herein.

FIG. 2 is a flowchart of an illustrative process carried out by an example information security system to identify vulnerabilities, in accordance with some embodiments of the technology described herein.

FIG. 3 is an exemplary chronological timeline of events, in accordance with some embodiments of the technology described herein.

FIG. 4 shows examples of sets of feature values for various events in the chronological timelines of events, in accordance with some embodiments of the technology described herein.

FIG. 5 is a screenshot illustrating a new event identified as an event for which a vulnerability mitigation action is to be triggered, in accordance with some embodiments of the technology described herein.

FIG. 6 is a screenshot illustrating an earlier event identified as an event for which a vulnerability mitigation action is to be triggered, in accordance with some embodiments of the technology described herein.

FIG. 7 shows a block diagram of an exemplary computing device, in accordance with some embodiments of the technology described herein

### DETAILED DESCRIPTION

CVE, short for Common Vulnerabilities and Exposures, is a vulnerability dictionary of publicly disclosed cybersecurity vulnerabilities and exposures. A CVE record is a unique identifier for a known cybersecurity vulnerability. The CVE record may include a CVE identifier which may be a unique alphanumeric identifier for the vulnerability, a brief description of the vulnerability, and information regarding references, such as, links to vulnerability reports or advisories.

Many new cybersecurity vulnerabilities are published every week, for example, at least 500 cybersecurity vulnerabilities per week, at least 600 cybersecurity vulnerabilities per week, at least 700 cybersecurity vulnerabilities per week, at least 800 cybersecurity vulnerabilities per week, at least 900 cybersecurity vulnerabilities per week, or at least 1000 cybersecurity vulnerabilities per week. For example, a total number of CVE records published during the year 2023 was 28,775 and a total number of CVE records published during the month of October 2024 was 3,575. For many of these vulnerabilities, additional content may be published over time, for example, news articles, research publications, and events such as government alerts. Vulnerability data obtained from various sources may be analyzed to identify events for which performance of vulnerability mitigation action(s) may need to be triggered.

While there are conventional techniques for identifying events for which vulnerability actions are to be triggered, the inventor recognized that such techniques can be improved. Some conventional techniques for identifying events for which vulnerability actions are to be triggered require manual review of the vulnerability data from one or multiple sources of such data. For example, a human analyst may periodically search for (either manually or using an automated tool) social media posts or published website articles to identify new events relating to existing vulnerabilities or new vulnerabilities. For example, the analyst may search among the descriptions of published CVE records for predefined keywords associated with new events related to a particular vulnerability or vulnerabilities. Unfortunately, due to the vast number of cybersecurity vulnerabilities being published every year, analysts are not able to efficiently review all the vulnerability data to determine which events require vulnerability mitigation action(s) to be triggered versus those which may not require immediate action. This may result in the computing environment being exposed to vulnerabilities when suitable vulnerability mitigation action(s) are not triggered in a timely manner.

Even when a human analyst identifies an event relating to a vulnerability, the event is assigned a score that can represent its significance and/or importance (which in turn can be used to guide whether this event is to trigger a subsequent vulnerability mitigation action, for example, by considering the magnitude of the score relative to scores of other detected events). A conventional scoring scheme called Exploit Prediction Scoring System (EPSS) is typically used to identify how likely exploitation of any given vulnerability will occur in a particular timeframe, for example, preceding 30 days. The EPSS scheme generates a score for a vulnerability but does not identify new vulnerabilities or events for which vulnerability mitigation action(s) may need to be triggered based on, for example, features relating to a timeline of events and/or relationships between events in the timeline.

To address the shortcomings of conventional techniques for identifying events for which vulnerability actions are to be triggered, the inventor has developed new techniques for identifying such events including for events related to new vulnerabilities and to existing vulnerabilities, which may have been publicly disclosed and/or published. These techniques process vulnerability data in a new way to identify events for which vulnerability mitigation action(s) may need to be triggered. In particular, the techniques involve continuous and automatic construction of a chronological timeline of events for published and/or publicly known vulnerability. Features from these timelines of events may be extracted and processed together with features from historical events to automatically identify newly occurring vulnerabilities or events for which vulnerability mitigation action(s) may need to be triggered. These techniques ensure that an analyst is alerted to new events in a timely and automated manner without the need for: (i) manual inspection of events, which is both time consuming and prone to gaps in visibility, where these gaps can expose the computing environment to high-risk vulnerabilities, and (ii) reliance on a list of predefined keywords for identifying events.

In some embodiments, the techniques developed by the inventor involve a method for identifying vulnerabilities in a computing environment comprising: (A) obtaining first vulnerability data for a first event from one or more external data sources (e.g., social media posts, RSS feeds, etc.); (B) associating the first event with a particular vulnerability in a vulnerability dictionary (e.g., CVE) using at least some of the first vulnerability data, the particular vulnerability being associated with one or more historical events; (C) enriching the first vulnerability data with first metadata comprising one or more time-based feature values (e.g., timestamps indicating when the first vulnerability data was obtained or first published) to obtain first enriched vulnerability data; (D) generating a first set of feature values for the first event using both: (i) the first enriched vulnerability data; and (ii) enriched vulnerability data for at least some of the one or more historical events; (E) determining, using the first set of feature values, that a vulnerability mitigation action (e.g., software updates, configuration changes of applications or operating systems executing on resources, deleting malware, removing corrupted files or data, etc.) is to be triggered for the first event; and (F) triggering performance of the vulnerability mitigation action for the first event.

In some embodiments, the first event is a current event, a new event, or an earlier event ingested into the system from the one or more external data sources. The one or more external data sources may include one or more of the following: (i) data obtained from one or more vulnerability databases; (ii) data obtained from one or more cybersecurity tools via one or more application programming interfaces (APIs); (iii) RSS feeds obtained from one or more websites; (iv) content shared on one or more social media platforms; and (v) third party content identified as being referenced in any of (i)-(iv).

In some embodiments, the method may further include obtaining second vulnerability data for each of multiple events from the one or more external data sources; and for each of the multiple events: associating the event with a particular vulnerability in the vulnerability dictionary using at least some of the corresponding second vulnerability data; enriching the second vulnerability data with second metadata comprising one or more time-based feature values to obtain second enriched vulnerability data; and storing the second enriched vulnerability data in a database.

In some embodiments, the one or more time-based feature values may include a timestamp indicating when the first vulnerability data was obtained; and/or a timestamp indicating when the first vulnerability data was first published.

In some embodiments, the first metadata may include one or more of the following: (i) a timestamp indicating when the first vulnerability data was obtained; (ii) a timestamp indicating when the first vulnerability data was first published; (iii) one or more metrics indicative of characteristics of the first vulnerability data; (iv) origin information regarding the first vulnerability data; and (v) one or more tag values identifying one or more properties that the first vulnerability data has in common with other portions of data obtained from the one or more external data sources.

In some embodiments, associating the first event with a particular vulnerability in a vulnerability dictionary using at least some of the first vulnerability data may include: identifying a Common Vulnerabilities and Exposures (CVE) identifier corresponding to a vulnerability referenced in the first vulnerability data; and associating the first event with the particular vulnerability in the vulnerability dictionary based on the CVE identifier.

In some embodiments, the first set of feature values for the first event may include one or more of the following: (i) a feature value indicating a distance in time between the first event and a previous event; (ii) a feature value indicating a distance in time between the first event and an epoch event; (iii) a feature value corresponding to a tag associated with the first event; (iv) a feature value corresponding to a tag associated with the previous event; (v) a feature value indicating an origin associated with the first event; (vi) a feature value indicating an origin associated with the previous event; and (vii) a bitmap of binary values indicating an occurrence of: a prior event, a prior condition and/or a prior feature.

In some embodiments, generating a first set of feature values for the first event may include: generating the first set of feature value for the first event using (i) the first enriched vulnerability data associated with the first event, the first event being a current event; and (ii) enriched vulnerability data associated with a previous event.

In some embodiments, determining, using the first set of feature values, that a vulnerability mitigation action is to be triggered for the first event may include: processing the first set of feature values using one or more rules defining criteria for identifying events for which a vulnerability mitigation action is to be triggered.

In some embodiments, determining, using the first set of feature values, that a vulnerability mitigation action is to be triggered for the first event may include: comparing, using a locality hashing technique, the first set of feature values to a second set of feature values associated with the at least some of the one or more historical events.

In some embodiments, determining, using the first set of feature values, that a vulnerability mitigation action is to be triggered for the first event may include: analyzing, using one or more machine learning models, the first set of feature values and a second set of feature values associated with the at least some of the one or more historical events.

In some embodiments, the vulnerability mitigation action for the first event may include at least one of: sending an alert, updating software, changing a network configuration of a resource, changing a configuration of one or more software applications executing on the resource, changing a configuration of an operating system executing on the resource, changing one or more permissions for the resource, deleting malware, removing corrupted files or data, taking a physical offline, killing an instance of a virtual resource, and blocking communications to and/or from the resource.

It should be appreciated that the techniques described herein may be implemented in any of numerous ways, as the techniques are not limited to any particular manner of implementation. Examples of details of implementation are provided herein solely for illustrative purposes. Furthermore, the techniques disclosed herein maybe used individually or in any suitable combination, as aspects of the technology described herein are not limited to the use of any particular technique or combination of techniques.

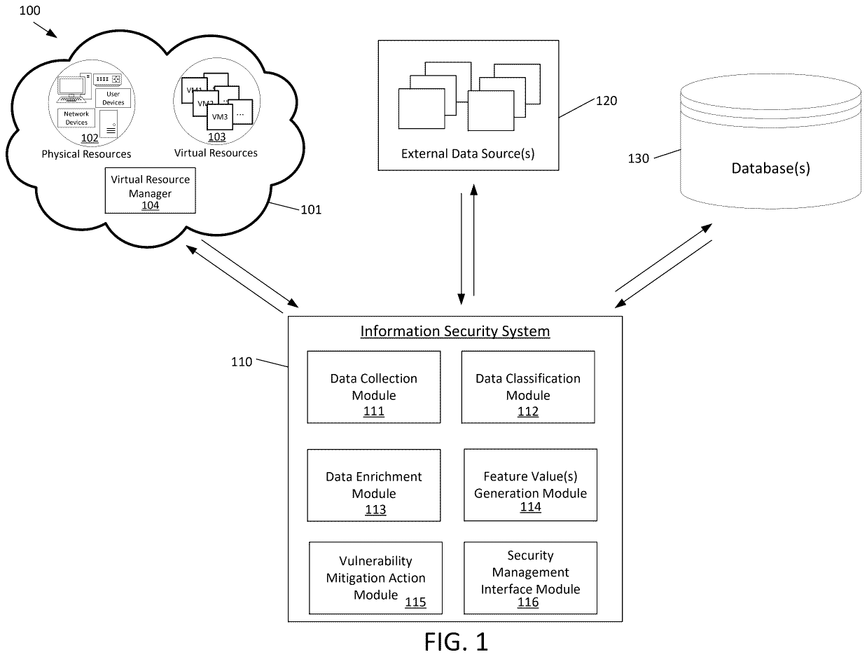

FIG. 1 shows an illustrative environment 100 in which an information security system may operate, in accordance with some embodiments of the technology described herein. The environment 100 includes a computing environment 101, an information security system 110, external source(s) 120, and database(s) 130.

The computing environment 101 is shown as a cloud computing environment, however, it may be any suitable computing environment, as described herein. In some embodiments, computing environment 101 may include addressable resources. Examples of computing environment resources include assets, storage resources (e.g., AWS S3 bucket), a queue (e.g., a queue provided by a cloud service), and/or any other type of data structure, in-memory object, software and/or hardware solution from which data may be collected and whose state may be monitored. An “asset” of a computing environment may refer to any addressable physical or virtual device part of the computing environment. An addressable physical device part of the computing environment may be referred to as a “physical resource.” An addressable virtual device part of the computing environment may be referred to as a “virtual resource.

Resources part of a computing environment 101 may be interconnected by one or more computer networks and each resource may have one or more addresses on the computer network(s). Each address may be of any suitable type and may be used to enable communication to/from a resource on the computer network(s). Non-limiting examples of addresses include an IP address (e.g., an IPv4 or an IPv6 address), a MAC address, an FTP address, an HTTP address, and a hostname. As can be appreciated from the foregoing, when a resource has multiple addresses, different addresses may be used to enable communication to/from the resource using different communication protocols. Though, some communication protocols may require use of multiple addresses (e.g., IP address and MAC address). Some types of addresses may be assigned by a computer network (e.g., an IP address). Other types of addresses are not assigned by the network and are particular to a device (e.g., a MAC address).

The computing environment includes resources including physical resources 102 and virtual resources 103. The computing environment additionally includes a virtual resource manager 104 which controls the access to and deployment of virtual resources 103 within the computing environment 101. Virtual resource manager 104 may comprise software for managing virtual resources 103 (e.g., by launching, monitoring, allocating resources to, shutting down VM instances). Though these are shown separately within FIG. 1, this is done for clarity of presentation, as virtual resources 103 and virtual resource manager 104 are software resources that execute on one or more physical resources 102.

The computing environment 101 may include any suitable number of resources of any suitable type. For example, physical resources 102 may include tens, hundreds, thousands, tens of thousands, hundreds of thousands, or millions, of addressable physical resources. As another example, virtual resources 103 may include tens, hundreds, thousands, tens of thousands, hundreds of thousands, millions, tens of millions, or hundreds of millions of virtual resources. As computing services continue to evolve and develop, a computing environment may include an even greater number of resources, and aspects of the technology described herein are not limited in this respect.

The computing environment 101 is connected to information security system 110. The information security system 110 may be configured to provide information security services with respect to the computing environment 101. Information security system 110 is shown as external to computing environment 101, however in some embodiments, one or more module(s) of information security system 110 may be deployed within computing environment 101. In some embodiments, information security system 110 may include one or more modules external to and one or more modules contained within the computing environment to which it is deployed.

The information security system 110 includes a data collection module 111, which communicates with the computing environment 101, external sources 120 and databases 130 to send and/or receive data, for example data related to cybersecurity vulnerabilities, events, and features of cybersecurity vulnerabilities, as described herein. The data collection module 111 may execute API calls to the external sources 120 and databases 130 to obtain data, or may receive data as it is automatically transmitted.

In some embodiments, the information security system 110 may send requests to external sources 120 to obtain vulnerability data. For example, the information security system 110 may make one or more API calls to external sources 120 to obtain vulnerability data. In some embodiments, the information security system 110 may make such requests on a set schedule, for example, once per day, every 12 hours, every 6 hours, every 2 hours or hourly. In some embodiments, the external sources 120 may automatically send vulnerability data to the information security system 110.

The data collection module 111 may obtain vulnerability data for multiple events from one or more external data sources 120. In some embodiments, the external sources 120 may include one or more of: external databases, websites, cybersecurity reporting sources, and threat intelligence feeds, among other data sources. In some embodiments, the external databases may include databases managed by cybersecurity service providers, universities, non-profit organizations, and government organizations, among other databases which contain cybersecurity vulnerability data. Embodiments of such databases include Cybersecurity and Infrastructure Security Agency (CISA) Known Exploited Vulnerabilities (KEV) catalog, and the NIST National Vulnerability Database (NVD). In some embodiments, the databases include proprietary databases accessible to the information security system. In some embodiments, the websites may include one or more of: websites hosted or managed by cybersecurity service providers, cybersecurity related forums, or social media websites, among other websites which contain information related to cybersecurity vulnerabilities. Examples of such websites include AttackerKB.com. In some embodiments, the cybersecurity reporting sources include one or more of: reporting sources managed by cybersecurity service providers, non-profit reporting sources, and government reporting sources, among other reporting sources which report information related to cybersecurity vulnerabilities. Examples of such reports include the Rapid7 Vulnerability Intelligence Report, and CISA Cybersecurity Alerts & Advisories. In some embodiments, the threat intelligence feeds include threat intelligence feeds managed by cybersecurity service providers, threat intelligence feeds managed by non-profit organizations and threat intelligence feeds managed by government organizations, among other threat intelligence feeds. Examples of threat intelligence feeds include Rapid7 IDR Alerts, Rapid7 MDR Alerts, InfraGard, Alien Vault, and Cyber Threat Information Sharing-Automated Indicator Sharing.

The external sources 120 may include one or more of the following: data obtained from one or more vulnerability databases (for example, databases managed by MITRE, NVD, CISA KEV catalog, and/or other databases); data obtained from one or more cybersecurity tools via one or more APIs (for example, data obtained from vulnerability intelligence platforms, such as AttackerKB); RSS feeds obtained from one or more websites (for example, known websites associated with software vendors, media organizations, cybersecurity vendors, and cybersecurity researchers); content shared on one or more social media platforms (for example, platforms such as Reddit, Twitter, Mastodon, and Bluesky); and third party content identified as being referenced in any of the aforementioned sources.

The information security system 110 includes a data classification module 112 which may, for each event of the multiple events, associate the event with a particular vulnerability in the vulnerability dictionary using at least some of the vulnerability data for the event. The particular vulnerability may be a previously known vulnerability identified in a CVE record and may be associated with one or more historical events. In some embodiments, the associating is performed by (i) identifying a CVE identifier corresponding to a vulnerability referenced in the vulnerability data for the event and (ii) associating the event with the particular vulnerability in the vulnerability dictionary based on the CVE identifier. In some embodiments, a suitable regular expression, such as /(cve-[0-9] {4}-[0-9] {4,19})/gi or any other suitable string-matching technique may be used for this purpose.

The information security system 110 includes a data enrichment module 113 which may, for each event of the multiple events, enrich the vulnerability data for the event with metadata to obtain enriched vulnerability data for the event and store the enriched vulnerability data in database 130. The metadata may include one or more time-based feature values. Examples of time-based feature values may include a timestamp indicating when the vulnerability data was obtained; and/or (ii) a timestamp indicating when the vulnerability data was first published. In some embodiments, the metadata may include additional information such as, one or more metrics indicative of characteristics of the vulnerability data (for example, a trust level indicating a degree to which the vulnerability data can be trusted as being accurate, and/or other metrics), origin information regarding the vulnerability data (for example, a source where the vulnerability data originated, such as a URL), and/or one or more tag values identifying one or more properties that the vulnerability data has in common with other portions of data obtained from the one or more external data sources 120 (for example, all vulnerability data obtained from a media organization may be tagged with a common “Media” tag).

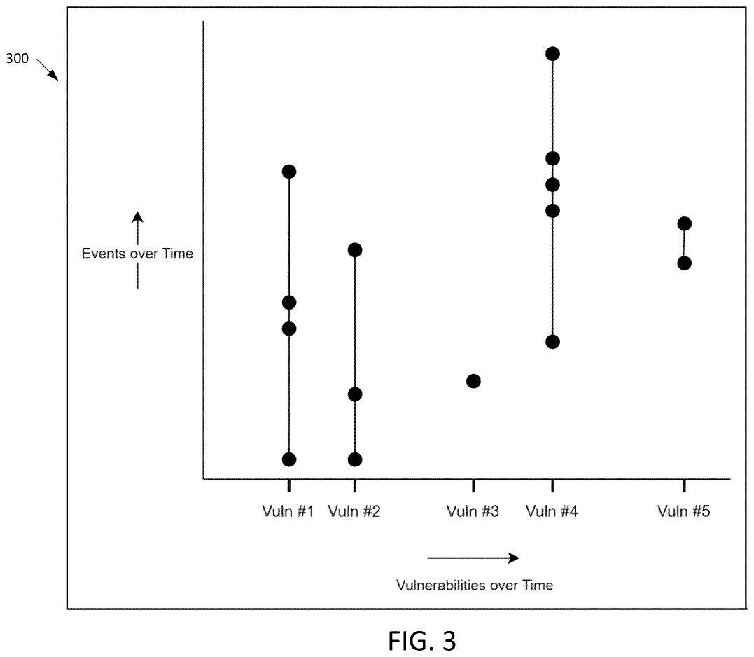

In some embodiments, the ingestion, classification, and enrichment of vulnerability data may be performed continuously or periodically. The vulnerability data that has been classified and enriched may be stored in a database, for example database 130. The stored vulnerability data may be used to generate a chronological timeline of events for every vulnerability that has been classified by the information security system 110. An example chronological timeline of events 300 is shown in FIG. 3.

As shown in FIG. 3, the classification associating each event with one or more vulnerabilities provides a location of the event on the X-axis and the enrichment with metadata including a timestamp indicating when the vulnerability data for the event was first published provides a location of the event on the Y-axis. Over time as new vulnerability data is obtained from the external sources 120, new timelines may be added for new vulnerabilities, and existing timelines may grow as new events occur for existing vulnerabilities.

The chronological timeline of events 300 indicates the relationship between events in the chronological timeline. For example, if exploitation of a vulnerability occurs and becomes publicly known, media organizations can be expected to begin publishing articles about the exploitation, resulting in many new media events close together. As another example, if new technical information about a vulnerability is discovered after a long period of inactivity, this can result in renewed interest in the vulnerability where prior to the discovery there was no interest.

Therefore, if a relationship exists between events, new events can be processed as they occur to recognize these relationships and determine if the new event is an event for which vulnerability mitigation action(s) may need to be triggered. The new event may look similar or equal to one or more historical events that have occurred previously and for which vulnerability mitigation actions may have been previously triggered or are to be triggered. In such cases, one or more vulnerability mitigation actions (e.g., generating an alert and sending it to an analyst) may be triggered for the new event.

In some embodiments, the data collection module 111, data classification module 112, and data enrichment module 113 may obtain, classify, and enrich the vulnerability data for events over time. The enriched vulnerability data for the events may be stored in database 130. These events may be historical events. Historical events for a vulnerability are events that have occurred previously and have been associated with the vulnerability. Information regarding these historical events may be used to process newly obtained vulnerability data to identify new events for which vulnerability mitigation action(s) may need to be triggered.

In some embodiments, the data collection module 111, data classification module 112, and data enrichment module 113 may obtain, classify, and enrich vulnerability data for a new event. The information security system 110 includes a feature value(s) generation module 114 which may generate a set of feature values for the new event using both: (i) the enriched vulnerability data for the new event; and (ii) enriched vulnerability data for at least some of the one or more historical events stored in database 130.

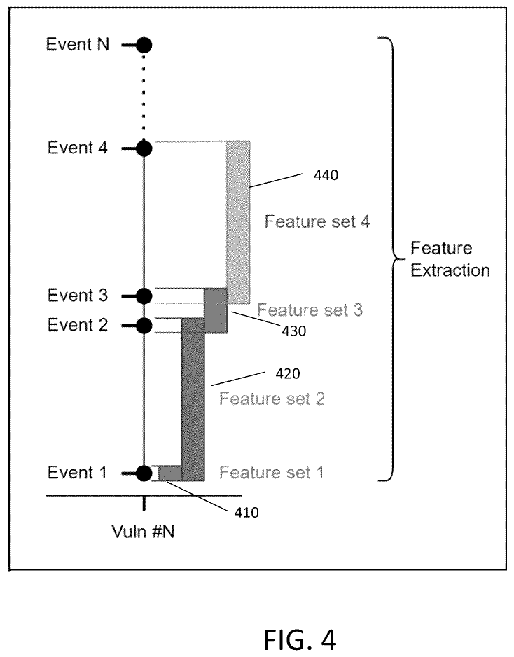

FIG. 4 shows a set of feature values generated for various events. A first set of feature values 410 may be generated for Event 1. Since Event 1 is the first event associated with vulnerability N in the chronological timeline of events, the first set of feature values may be generated using enriched vulnerability data for Event 1. A second set of feature values 420 may be generated for Event 2 using the enriched vulnerability data for Event 2 and preceding Event 1. A third set of feature values 430 may be generated for Event 3 using the enriched vulnerability data for Event 3 and preceding Event 2. A fourth set of feature values 440 may be generated for Event 4 using the enriched vulnerability data for Event 4 and preceding Event 3. Although, FIG. 4 depicts sets of feature values generated using vulnerability data associated with a current (e.g., new) event and a preceding event, the disclosure is not limited in this respect. For example, the sets of feature values may be generated using vulnerability data associated with a current (e.g., new) event and multiple preceding events.

The set of feature values may be a tuple of data describing the new event and its relationship with one or more previous (for example, preceding) or historical events. The set of feature values for the new event may include, but not be limited to: (i) a feature value indicating a distance in time between the new event and a previous event; (ii) a feature value indicating a distance in time between the new event and an epoch (i.e., first) event; (iii) one or more feature values corresponding to one or more tags associated with the new event; (iv) one or more feature values corresponding to one or more tags associated with the previous event; (v) a feature value indicating an origin associated with the new event; (vi) a feature value indicating an origin associated with the previous event; and (vii) a bitmap of binary values indicating an occurrence of: a prior event (for example, the publication of a CVE identifier or publication of an exploit), a prior condition (for example, if the new event is less than 1, 2, or N days since the epoch), and a prior feature (for example, if a specific feature has existed, thereby indicating any changes relative to a prior event). For example, event 1 occurs on November 1, event 2 occurs on November 2, and event 3 occurs several days later, on November 10. Event 1 may be the epoch event. For the condition described as “a new event occurring less than 2 days from the epoch”, this condition will be true for events 1 and 2, but false for event 3 and all subsequent events that occur chronologically after event 3. This technique allows a boolean condition within the feature set to be described, and the result of this boolean condition may be stored in a distinct value within the feature set. Other examples of such conditions may include, but not be limited to, a condition described as “a new event occurring less than 2 days from the epoch”, a condition described as “a new event occurring less than 3 days from the epoch”, or a condition described as “has an official CVE record been published?”, with the result of each condition stored in a distinct value within the feature set.

In some embodiments, bits in the bitmap of binary values are set over time and may not be cleared. For example, bit 0 in the bitmap may indicate if a vulnerability has a CVE identifier. That bit may remain 0 until the event which published a CVE occurs, at which point that bit may be switched to 1. The bit may remain 1 for the duration of the chronological timeline.

The information security system 110 includes a vulnerability mitigation action module 115 which may determine, using the set of feature values for the new event, whether a vulnerability mitigation action is to be triggered for the new event. In some embodiments, the set of feature values may be processed using various techniques to identify new vulnerabilities or events for which a vulnerability mitigation action is to be triggered. The set of feature values may be processed against feature values from historical events to identify newly occurring vulnerabilities or events that may be of interest to an analyst. The processing of the set of feature values may be performed using one or more static rules, using locality hashing techniques, using one or more machine learning models, and/or using other techniques.

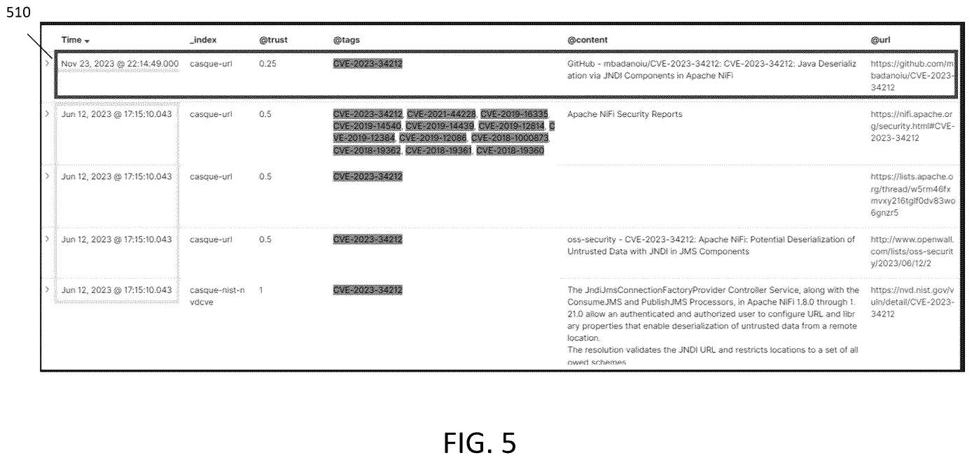

For example, the set of feature values for the new event may be processed using one or more rules defining criteria for identifying events for which a vulnerability mitigation action is to be triggered. In some embodiments, the criteria may specify features values associated with historical events for which vulnerability mitigation actions may have been previously triggered. FIG. 5 is a screenshot illustrating a new event 510 identified as an event for which a vulnerability mitigation action is to be triggered. As an example, the identification may be performed using a first rule defining criteria to capture the following scenario:
A new event occurring for a vulnerability that has no events occur for a prolonged period of time. This may be seen when new technical information about a vulnerability comes to light. Often this precedes renewed interest in the vulnerability. For example, as shown in FIG. 5, CVE-2023-34212 had initial events occur on Jun. 12, 2023, and then no further events occurred for several months until Nov. 23, 2023 when an exploit was published. This new event 510 may be identified as an event for which a vulnerability mitigation action is to be triggered.

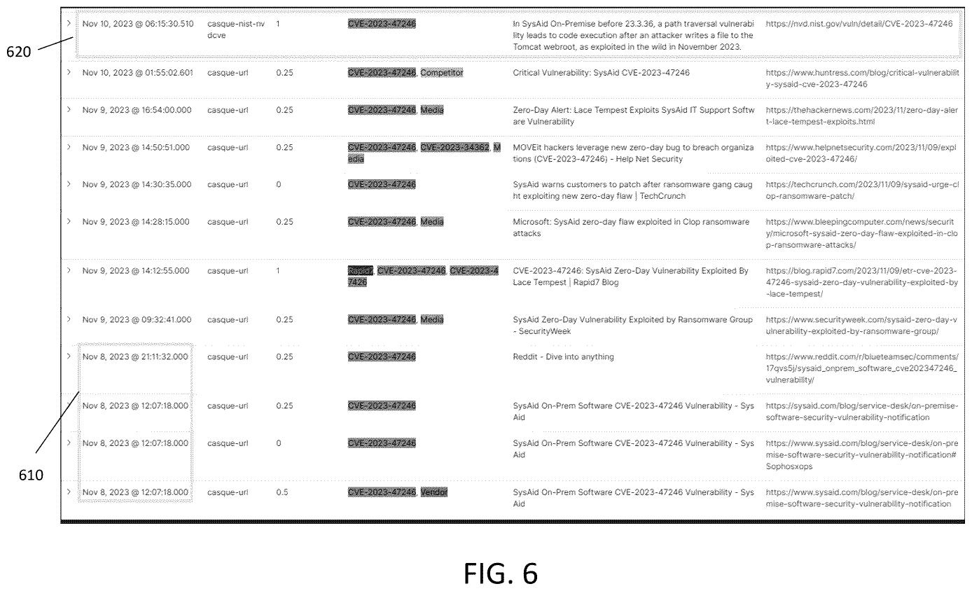

FIG. 6 is a screenshot illustrating one or more earlier events 610 identified as events for which a vulnerability mitigation action is to be triggered based on processing the set of feature values for a new event 620. As another example, the identification may be performed using a second rule defining criteria to capture the following scenario:
An event, such as a research publication, occurring before a vulnerability has been publicly disclosed or has had a CVE identifier published. This may occur when a researcher publishing information about the vulnerability has some prior knowledge of the vulnerability, for example if he is the original finder. For example, as shown in FIG. 6, CVE-2023-47246 has its CVE identifier published on Nov. 10, 2023. However, events occurred as early as Nov. 8, 2023, on social media. These early events 610 may be identified as events for which a vulnerability mitigation action is to be triggered.

As another example, the set of feature values for the new event may be processed using one or more locality hashing techniques. The set of feature values may be compared to a second set of feature values associated with one or more historical events using a locality hashing technique. For example, locality sensitive hashing techniques may be used. Locality sensitive hashing (LSH) techniques involve generating hashes such that the hashes of two similar objects are also similar or the same. As a result, LSH techniques may be used to generate hashes that may be compared against other hashes (e.g., using a suitable measure of similarity such as, for example, Hamming distance) to see how similar different objects may be. Different locality sensitive hashing techniques may be employed by the technology developed by inventors, in different embodiments. For example, as described herein, in some embodiments, a minimum hashing LSH technique may be employed. As another example, as described herein, in some embodiments, an LSH technique based on randomized hyperplanes may be employed.

In some embodiments, an LSH technique may be applied to a set of feature values for the new event resulting in a first hashed signature. The LSH technique may be applied to feature values for one or more historical events resulting in one or more second hashed signatures. The first hashed signature may be compared with the one or more second hashed signatures to determine whether the new event is an event for which a vulnerability mitigation action is to be triggered. For example, when the first hashed signature is similar to at least one of the one or more second hashed signatures, a determination may be made that the new event is an event for which a vulnerability mitigation action is to be triggered.

In some embodiments, locality sensitive hashing can identify new events that appear similar to historical events for which vulnerability mitigation actions may have been previously triggered. For example, historical vulnerabilities/events may be identified as follows, but not limited to:
Automatically identify all previous vulnerabilities/events that a cybersecurity provider, such as Rapid7, has engaged the Emergent Threat Response (ETR) program to.
Automatically identify all previous vulnerabilities/events CISA has added to the known exploitable vulnerabilities (KEV) list.
Manually identify all previous vulnerabilities/events that are good examples of the type of vulnerabilities to be identified in the future.

Knowing a set of historical events for which vulnerability mitigation actions may have been triggered, locality sensitive hashes can be generated for the feature values of these historical events. When new events are ingested into the system, the features values for the new events can be compared to the feature values of known historical events to determine whether they are similar. This can be achieved by leveraging a locality sensitive hashing technique to match similar feature sets.

As yet another example, the set of feature values for the new event may be processed using one or more machine learning models. In some embodiments, the set of feature values associated with the new event and a second set of feature values associated with one or more historical events may be analyzed using one or more machine learning models. Any suitable machine learning model may be used as the disclosure is not limited in this respect. For example, any supervised or unsupervised machine learning model trained to analyze sets of feature values may be used.

The vulnerability mitigation action module 115 may trigger performance of a vulnerability mitigation action for the new event. In some embodiments, the vulnerability mitigation action module 115 may provide information on vulnerabilities, for example vulnerability reports or suggested vulnerability mitigation actions to security management interface module 116 of the information security system 110. The security management interface module 116 may let one or more administrators of the information security system 110 to view and address vulnerabilities, for example by performing one or more vulnerability mitigation actions or by prioritizing vulnerabilities for vulnerability mitigation actions.

In some embodiments, the one or more vulnerability mitigation actions may be performed without user input indicating the one or more actions are to be performed. In some examples, the system may perform the one or more vulnerability mitigation actions in response to receiving a user input indicating the one or more actions are to be performed. Vulnerability mitigation actions to address one or more cybersecurity vulnerabilities may be performed automatically (e.g., by an information security system) or manually (e.g., by one or more system administrators). Non-limiting examples of vulnerability mitigation actions include generating an alert regarding the vulnerability and associated vulnerability mitigation action, updating software (e.g., by installing a newer version of the software, applying a patch), changing the network configuration of a resource, changing the configuration of one or more software applications executing on the resource, changing the configuration of an operating system executing on the resource, changing one or more permissions for the resource, deleting malware, removing corrupted files or data, taking a physical offline, killing an instance of a virtual resource, and blocking communications to and/or from the resource.

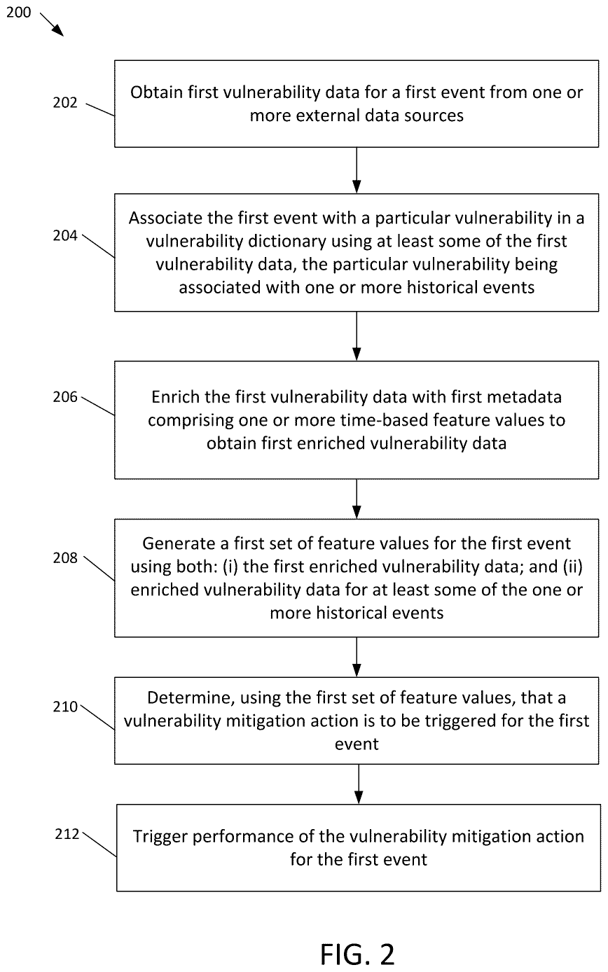

FIG. 2 is a flow chart of a process 200 carried out by an example information security system, to identify cybersecurity vulnerabilities in a computing environment, in accordance with some embodiments of the technology described herein. The process 200 may be performed by any suitable computing device. For example, in some embodiments, the process 200 may be performed by information security system 110, aspects of which are described herein including with reference to FIG. 1.

Process 200 begins at act 202, in which first vulnerability data for a first event may be obtained from one or more external data sources 120. In some embodiments, the vulnerability data for multiple events may be obtained from the one or more external data sources 120 by data collection module 111.

The process may then proceed to act 204, where the first event may be associated with a particular vulnerability in the vulnerability dictionary using at least some of the first vulnerability data. The particular vulnerability may be associated with one or more historical events. In some embodiments, associating the first event with the particular vulnerability may be performed by data classification module 112. The associating may be performed by identifying a CVE identifier corresponding to a vulnerability referenced in the first vulnerability data, and associating the first event with the particular vulnerability in the vulnerability dictionary based on the CVE identifier.

In some embodiments, where the vulnerability referenced in the first vulnerability data is a zero-day vulnerability, there may not be a CVE identifier assigned to it yet. Classification in this case may be performed in a bespoke manner, where an analyst may create several keywords thought to be common in any vulnerability data pertaining to a specific zero-day vulnerability. Any vulnerability data ingested that match these keywords may be classified using a pseudo vulnerability identifier, unique to each zero-day vulnerability. At a later point in time when an official CVE identifier has been assigned, this pseudo vulnerability identifier may be associated with the official CVE identifier, merging all vulnerability data classified with both the pseudo vulnerability identifier and the official CVE identifier together.

In some embodiments, in cases where a determination cannot be made regarding which vulnerability to associate the first event with, the first vulnerability data for the first event may be dropped and no further processing may occur.

The process may then proceed to act 206, where the first vulnerability data may be enriched with first metadata comprising one or more time-based feature values to obtain first enriched vulnerability data. The one or more time-based feature values may include a timestamp indicating when the first vulnerability data was obtained and/or a timestamp indicating when the first vulnerability data was first published. The time-based feature values may be used to determine the location of event in the chronological timelines of events.

At act 208, a first set of feature values may be generated for the first event using both: (i) the first enriched vulnerability data; and (ii) enriched vulnerability data for at least some of the one or more historical events. The process then proceeds to act 210, where the first set of feature values are used to determine that a vulnerability mitigation action is to be triggered for the first event. For example, static rules, locality sensitive hashing techniques, and/or machine learning models may be used to make the determination as described herein.

At act 212, performance of the vulnerability mitigation action may be triggered for the first event. Examples of vulnerability mitigation actions may include, but not be limited to, updating software, changing a network configuration of a resource, changing a configuration of one or more software applications executing on the resource, changing a configuration of an operating system executing on the resource, changing one or more permissions for the resource, deleting malware, removing corrupted files or data, taking a physical offline, killing an instance of a virtual resource, and blocking communications to and/or from the resource.

In some embodiments, acts 202, 204, and 206 may be performed for each of multiple events such that enriched vulnerability data for each of the multiple events may be stored in database 130 and used to generate a chronological timeline of events (as shown in FIG. 3, for example). The acts 202, 204, 206, 208, 210, and 212 may then be performed for newly ingested events to determine whether vulnerability mitigation action(s) are to be triggered for the newly ingested events.

In some embodiments, a vulnerability mitigation action may include either alerting a user to the occurrence of the first event, or further processing of either the first event or all events in the chronological timeline for the vulnerability, in order to further refine the event identification (for example, by reducing false positives by further processing). For a particular vulnerability, a pool of events may be maintained. Vulnerability mitigation actions may be triggered when events in the pool meet one or more criteria and/or thresholds. For example, a vulnerability mitigation action may be triggered when the pool includes a threshold number of new events sufficiently similar to historical events. In some embodiments, an event for which a determination is made that vulnerability mitigation action(s) are to be triggered (during act 210, for example) may be added to the pool of events. In some embodiments, rather than proceeding directly to act 212 after act 210, this event can be first added to the pool, if it has not already been added. A threshold value may be maintained, and for any given event in the pool to proceed to be actioned by act 212, a determination may be made regarding whether the threshold value is met. For example, a threshold value may indicate a fixed number of distinct matches in a particular time period (e.g., 3 matches with historical events over a 24 hour period). When an event in the pool achieves the threshold number of distinct matches from act 210 over a period of time, the event may be removed from the pool and actioned by act 212. Events in the pool that do not meet a threshold value over a period of time (e.g. 24 hours), may be removed from the pool.

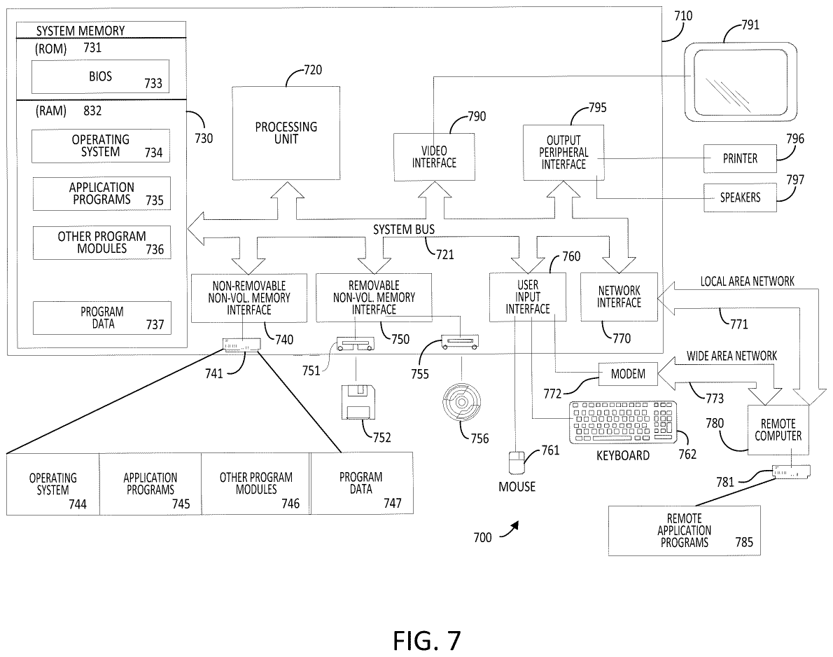

FIG. 7 shows a block diagram of an exemplary computing device, in accordance with some embodiments of the technology described herein. The computing system environment 700 is only one example of a suitable computing environment and is not intended to suggest any limitation as to the scope of use or functionality of the technology described herein.

The technology described herein is operational with numerous other general purpose or special purpose computing system environments or configurations. Examples of well-known computing systems, environments, and/or configurations that may be suitable for use with the technology described herein include, but are not limited to, personal computers, server computers, hand-held or laptop devices, multiprocessor systems, microprocessor-based systems, set top boxes, programmable consumer electronics, network PCs, minicomputers, mainframe computers, distributed computing environments that include any of the above systems or devices, and the like.

The computing environment may execute computer-executable instructions, such as program modules. Generally, program modules include routines, programs, objects, components, data structures, etc. that perform particular tasks or implement particular abstract data types. The technology described herein may also be practiced in distributed computing environments where tasks are performed by remote processing devices that are linked through a communications network. In a distributed computing environment, program modules may be located in both local and remote computer storage media including memory storage devices.

With reference to FIG. 7, an exemplary system for implementing the technology described herein includes a general-purpose computing device in the form of a computer 710. Components of computer 710 may include, but are not limited to, a processing unit 720, a system memory 730, and a system bus 721 that couples various system components including the system memory to the processing unit 720. The system bus 721 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

Computer 710 typically includes a variety of computer readable media. Computer readable media can be any available media that can be accessed by computer 710 and includes both volatile and nonvolatile media, removable and non-removable media. By way of example, and not limitation, computer readable media may comprise computer storage media and communication media. Computer storage media includes volatile and nonvolatile, removable, and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computer 710. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer readable media.

The system memory 730 includes computer storage media in the form of volatile and/or nonvolatile memory such as read only memory (ROM) 731 and random access memory (RAM) 732. A basic input/output system 733 (BIOS), containing the basic routines that help to transfer information between elements within computer 710, such as during start-up, is typically stored in ROM 731. RAM 732 typically contains data and/or program modules that are immediately accessible to and/or presently being operated on by processing unit 720. By way of example, and not limitation, FIG. 7 illustrates operating system 734, application programs 735, other program modules 736, and program data 737.

The computer 710 may also include other removable/non-removable, volatile or nonvolatile computer storage media. By way of example only, FIG. 7 illustrates a hard disk drive 741 that reads from or writes to non-removable, nonvolatile magnetic media, a flash drive 751 that reads from or writes to a removable, nonvolatile memory 752 such as flash memory, and an optical disk drive 755 that reads from or writes to a removable, nonvolatile optical disk 756 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 741 is typically connected to the system bus 721 through a non-removable memory interface such as interface 740, and magnetic disk drive 751 and optical disk drive 755 are typically connected to the system bus 721 by a removable memory interface, such as interface 750.

The drives and their associated computer storage media described above and illustrated in FIG. 7, provide storage of computer readable instructions, data structures, program modules and other data for the computer 710. In FIG. 7, for example, hard disk drive 741 is illustrated as storing operating system 744, application programs 745, other program modules 746, and program data 747. Note that these components can either be the same as or different from operating system 734, application programs 735, other program modules 736, and program data 737. Operating system 744, application programs 745, other program modules 746, and program data 747 are given different numbers here to illustrate that, at a minimum, they are different copies. An actor may enter commands and information into the computer 710 through input devices such as a keyboard 762 and pointing device 761, commonly referred to as a mouse, trackball, or touch pad. Other input devices (not shown) may include a microphone, joystick, game pad, satellite dish, scanner, or the like. These and other input devices are often connected to the processing unit 720 through a user input interface 760 that is coupled to the system bus but may be connected by other interface and bus structures, such as a parallel port, game port or a universal serial bus (USB). A monitor 791 or other type of display device is also connected to the system bus 721 via an interface, such as a video interface 790. In addition to the monitor, computers may also include other peripheral output devices such as speakers 797 and printer 796, which may be connected through an output peripheral interface 795.

The computer 710 may operate in a networked environment using logical connections to one or more remote computers, such as a remote computer 780. The remote computer 780 may be a personal computer, a server, a router, a network PC, a peer device, or other common network node, and typically includes many or all of the elements described above relative to the computer 710, although only a memory storage device 781 has been illustrated in FIG. 7. The logical connections depicted in FIG. 7 include a local area network (LAN) 771 and a wide area network (WAN) 773 but may also include other networks. Such networking environments are commonplace in offices, enterprise-wide computer networks, intranets, and the Internet.

When used in a LAN networking environment, the computer 710 is connected to the LAN 771 through a network interface or adapter 770. When used in a WAN networking environment, the computer 710 typically includes a modem 772 or other means for establishing communications over the WAN 773, such as the Internet. The modem 772, which may be internal or external, may be connected to the system bus 721 via the actor input interface 760, or other appropriate mechanism. In a networked environment, program modules depicted relative to the computer 710, or portions thereof, may be stored in the remote memory storage device. By way of example, and not limitation, FIG. 7 illustrates remote application programs 785 as residing on memory device 781. It will be appreciated that the network connections shown are exemplary and other means of establishing a communications link between the computers may be used.

Having thus described several aspects of at least one embodiment of the technology described herein, it is to be appreciated that various alterations, modifications, and improvements will readily occur to those skilled in the art. Such alterations, modifications, and improvements are intended to be part of this disclosure and are intended to be within the spirit and scope of disclosure. Further, though advantages of the technology described herein are indicated, it should be appreciated that not every embodiment of the technology described herein will include every described advantage. Some embodiments may not implement any features described as advantageous herein and in some instances one or more of the described features may be implemented to achieve further embodiments. Accordingly, the foregoing description and drawings are by way of example only.

The above-described embodiments of the technology described herein can be implemented in any of numerous ways. For example, the embodiments may be implemented using hardware, software, or a combination thereof. When implemented in software, the software code can be executed on any suitable processor or collection of processors, whether provided in a single computer or distributed among multiple computers. Such processors may be implemented as integrated circuits, with one or more processors in an integrated circuit component, including commercially available integrated circuit components known in the art by names such as CPU chips, GPU chips, microprocessor, microcontroller, or co-processor. Alternatively, a processor may be implemented in custom circuitry, such as an ASIC, or semicustom circuitry resulting from configuring a programmable logic device. As yet a further alternative, a processor may be a portion of a larger circuit or semiconductor device, whether commercially available, semi-custom or custom. As a specific example, some commercially available microprocessors have multiple cores such that one or a subset of those cores may constitute a processor. However, a processor may be implemented using circuitry in any suitable format.

Further, it should be appreciated that a computer may be embodied in any of a number of forms, such as a rack-mounted computer, a desktop computer, a laptop computer, a tablet computer, a Personal Digital Assistant (PDA), a smart phone or any other suitable portable or fixed electronic device.

Also, a computer may have one or more input and output devices. These devices can be used, among other things, to present a user interface. Examples of output devices that can be used to provide a user interface include printers or display screens for visual presentation of output and speakers or other sound generating devices for audible presentation of output. Examples of input devices that can be used for a user interface include keyboards, and pointing devices, such as mice, touch pads, and digitizing tablets. As another example, a computer may receive input information through speech recognition or in other audible format.

Such computers may be interconnected by one or more networks in any suitable form, including as a local area network or a wide area network, such as an enterprise network or the Internet. Such networks may be based on any suitable technology and may operate according to any suitable protocol and may include wireless networks, wired networks or fiber optic networks.

Also, the various methods or processes outlined herein may be coded as software that is executable on one or more processors that employ any one of a variety of operating systems or platforms. Additionally, such software may be written using any of a number of suitable programming languages and/or programming or scripting tools, and also may be compiled as executable machine language code or intermediate code that is executed on a framework or virtual machine.

In this respect, aspects of the technology described herein may be embodied as a computer readable storage medium (or multiple computer readable media) (e.g., a computer memory, one or more floppy discs, compact discs (CD), optical discs, digital video disks (DVD), magnetic tapes, flash memories, circuit configurations in Field Programmable Gate Arrays or other semiconductor devices, or other tangible computer storage medium) encoded with one or more programs that, when executed on one or more computers or other processors, perform methods that implement the various embodiments described above. As is apparent from the foregoing examples, a computer readable storage medium may retain information for a sufficient time to provide computer-executable instructions in a non-transitory form. Such a computer readable storage medium or media can be transportable, such that the program or programs stored thereon can be loaded onto one or more different computers or other processors to implement various aspects of the technology as described above. A computer-readable storage medium includes any computer memory configured to store software, for example, the memory of any computing device such as a smart phone, a laptop, a desktop, a rack-mounted computer, or a server (e.g., a server storing software distributed by downloading over a network, such as an app store)). As used herein, the term “computer-readable storage medium” encompasses only a non-transitory computer-readable medium that can be considered to be a manufacture (i.e., article of manufacture) or a machine. Alternatively, or additionally, aspects of the technology described herein may be embodied as a computer readable medium other than a computer-readable storage medium, such as a propagating signal.

The terms “program” or “software” are used herein in a generic sense to refer to any type of computer code or set of processor-executable instructions that can be employed to program a computer or other processor to implement various aspects of the technology as described above. Additionally, it should be appreciated that according to one aspect of this embodiment, one or more computer programs that when executed perform methods of the technology described herein need not reside on a single computer or processor but may be distributed in a modular fashion among a number of different computers or processors to implement various aspects of the technology described herein.

Computer-executable instructions may be in many forms, such as program modules, executed by one or more computers or other devices. Generally, program modules include routines, programs, objects, components, data structures, etc. that perform particular tasks or implement particular abstract data types. Typically, the functionality of the program modules may be combined or distributed as desired in various embodiments.

Also, data structures may be stored in computer-readable media in any suitable form. For simplicity of illustration, data structures may be shown to have fields that are related through location in the data structure. Such relationships may likewise be achieved by assigning storage for the fields with locations in a computer-readable medium that conveys relationship between the fields. However, any suitable mechanism may be used to establish a relationship between information in fields of a data structure, including through the use of pointers, tags or other mechanisms that establish relationship between data elements.

Various aspects of the technology described herein may be used alone, in combination, or in a variety of arrangements not specifically described in the embodiments described in the foregoing and is therefore not limited in its application to the details and arrangement of components set forth in the foregoing description or illustrated in the drawings. For example, aspects described in one embodiment may be combined in any manner with aspects described in other embodiments.

Also, the technology described herein may be embodied as a method, of which examples are provided herein including with reference to FIG. 2. The acts performed as part of any of the methods may be ordered in any suitable way. Accordingly, embodiments may be constructed in which acts are performed in an order different than illustrated, which may include performing some acts simultaneously, even though shown as sequential acts in illustrative embodiments.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B,” when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively.

The terms “approximately” and “about” may be used to mean within ±20% of a target value in some embodiments, within ±10% of a target value in some embodiments, within ±5% of a target value in some embodiments, within ±2% of a target value in some embodiments. The terms “approximately” and “about” may include the target value.

Use of ordinal terms such as “first,” “second,” “third,” etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

What is claimed is:

1. A method for identifying vulnerabilities in a computing environment, the method comprising:
using at least one computer hardware processor to perform:
obtaining first vulnerability data for a first event from one or more external data sources;
associating the first event with a particular vulnerability in a vulnerability dictionary using at least some of the first vulnerability data, the particular vulnerability being associated with one or more historical events;
enriching the first vulnerability data with first metadata comprising one or more time-based feature values to obtain first enriched vulnerability data;
generating a first set of feature values for the first event using both: (i) the first enriched vulnerability data; and (ii) enriched vulnerability data for at least some of the one or more historical events;
determining, using the first set of feature values, that a vulnerability mitigation action is to be triggered for the first event; and
triggering performance of the vulnerability mitigation action for the first event.

2. The method of claim 1, wherein the one or more external data sources comprises one or more of the following:
(i) data obtained from one or more vulnerability databases;
(ii) data obtained from one or more cybersecurity tools via one or more application programming interfaces (APIs);
(iii) RSS feeds obtained from one or more websites;
(iv) content shared on one or more social media platforms; and
(v) third party content identified as being referenced in any of (i)-(iv).

3. The method of claim 1, further comprising:
obtaining second vulnerability data for each of multiple events from the one or more external data sources; and
for each of the multiple events:
associating the event with a particular vulnerability in the vulnerability dictionary using at least some of the corresponding second vulnerability data;
enriching the second vulnerability data with second metadata comprising one or more time-based feature values to obtain second enriched vulnerability data; and
storing the second enriched vulnerability data in a database.

4. The method of claim 1, wherein the one or more time-based feature values comprises:
(i) a timestamp indicating when the first vulnerability data was obtained; and/or
(ii) a timestamp indicating when the first vulnerability data was first published.

5. The method of claim 1, wherein the first metadata comprises:
(i) a timestamp indicating when the first vulnerability data was obtained;
(ii) a timestamp indicating when the first vulnerability data was first published;
(iii) one or more metrics indicative of characteristics of the first vulnerability data;
(iv) origin information regarding the first vulnerability data; and
(v) one or more tag values identifying one or more properties that the first vulnerability data has in common with other portions of data obtained from the one or more external data sources.

6. The method of claim 1, wherein associating the first event with a particular vulnerability in a vulnerability dictionary using at least some of the first vulnerability data comprises:
identifying a Common Vulnerabilities and Exposures (CVE) identifier corresponding to a vulnerability referenced in the first vulnerability data; and
associating the first event with the particular vulnerability in the vulnerability dictionary based on the CVE identifier.

7. The method of claim 1, wherein the first set of feature values for the first event comprises one or more of the following:
(i) a feature value indicating a distance in time between the first event and a previous event;
(ii) a feature value indicating a distance in time between the first event and an epoch event;
(iii) a feature value corresponding to a tag associated with the first event;
(iv) a feature value corresponding to a tag associated with the previous event;
(v) a feature value indicating an origin associated with the first event;
(vi) a feature value indicating an origin associated with the previous event; and
(vii) a bitmap of binary values indicating an occurrence of: a prior event, a prior condition, and/or a prior feature.

8. The method of claim 1, wherein generating a first set of feature values for the first event comprises:
generating the first set of feature values for the first event using (i) the first enriched vulnerability data associated with the first event, the first event being a current event; and (ii) enriched vulnerability data associated with a previous event.

9. The method of claim 1, wherein generating a first set of feature values for the first event comprises:
generating the first set of feature values for the first event using (i) the first enriched vulnerability data associated with the first event, the first event being a current event; and (ii) enriched vulnerability data for multiple preceding events.

10. The method of claim 1, wherein determining, using the first set of feature values, that a vulnerability mitigation action is to be triggered for the first event comprises:
processing the first set of feature values using one or more rules defining criteria for identifying events for which a vulnerability mitigation action is to be triggered.

11. The method of claim 1, wherein determining, using the first set of feature values, that a vulnerability mitigation action is to be triggered for the first event comprises:
comparing, using a locality hashing technique, the first set of feature values to a second set of feature values associated with the at least some of the one or more historical events.

12. The method of claim 1, wherein determining, using the first set of feature values, that a vulnerability mitigation action is to be triggered for the first event comprises:
analyzing, using one or more machine learning models, the first set of feature values and a second set of feature values associated with the at least some of the one or more historical events.

13. The method of claim 1, wherein the vulnerability mitigation action for the first event comprises at least one of: generating an alert, updating software, changing a network configuration of a resource, changing a configuration of one or more software applications executing on the resource, changing a configuration of an operating system executing on the resource, changing one or more permissions for the resource, deleting malware, removing corrupted files or data, taking a physical offline, killing an instance of a virtual resource, and blocking communications to and/or from the resource.

14. A system for identifying vulnerabilities in a computing environment, the system comprising:
at least one computer hardware processor; and
at least one non-transitory computer-readable storage medium storing processor-executable instructions that, when executed by the at least one computer hardware processor, causes the at least one computer hardware processor to perform a method comprising:
obtaining first vulnerability data for a first event from one or more external data sources;
associating the first event with a particular vulnerability in a vulnerability dictionary using at least some of the first vulnerability data, the particular vulnerability being associated with one or more historical events;
enriching the first vulnerability data with first metadata comprising one or more time-based feature values to obtain first enriched vulnerability data;
generating a first set of feature values for the first event using both: (i) the first enriched vulnerability data; and (ii) enriched vulnerability data for at least some of the one or more historical events;
determining, using the first set of feature values, that a vulnerability mitigation action is to be triggered for the first event; and
triggering performance of the vulnerability mitigation action for the first event.

15. The system of claim 14, wherein the method further comprises:
obtaining second vulnerability data for each of multiple events from the one or more external data sources; and
for each of the multiple events:
associating the event with a particular vulnerability in the vulnerability dictionary using at least some of the corresponding second vulnerability data;
enriching the second vulnerability data with second metadata comprising one or more time-based feature values to obtain second enriched vulnerability data; and
storing the second enriched vulnerability data in a database.

16. The system of claim 14, wherein associating the first event with a particular vulnerability in a vulnerability dictionary using at least some of the first vulnerability data comprises:
identifying a Common Vulnerabilities and Exposures (CVE) identifier corresponding to a vulnerability referenced in the first vulnerability data; and associating the first event with the particular vulnerability in the vulnerability dictionary based on the CVE identifier

17. The system of claim 14, wherein determining, using the first set of feature values, that a vulnerability mitigation action is to be triggered for the first event comprises:
processing the first set of feature values using one or more rules defining criteria for identifying events for which a vulnerability mitigation action is to be triggered.

18. The system of claim 14, wherein determining, using the first set of feature values, that a vulnerability mitigation action is to be triggered for the first event comprises:
comparing, using a locality hashing technique, the first set of feature values to a second set of feature values associated with the at least some of the one or more historical events.

19. The system of claim 14, wherein determining, using the first set of feature values, that a vulnerability mitigation action is to be triggered for the first event comprises:
analyzing, using one or more machine learning models, the first set of feature values and a second set of feature values associated with the at least some of the one or more historical events.

20. At least one non-transitory computer-readable storage medium storing processor executable instructions that, when executed by at least one computer hardware processor, causes the at least one computer hardware processor to perform a method for identifying vulnerabilities in a computing environment, the method comprising:
obtaining first vulnerability data for a first event from one or more external data sources;
associating the first event with a particular vulnerability in a vulnerability dictionary using at least some of the first vulnerability data, the particular vulnerability being associated with one or more historical events;
enriching the first vulnerability data with first metadata comprising one or more time-based feature values to obtain first enriched vulnerability data;
generating a first set of feature values for the first event using both: (i) the first enriched vulnerability data; and (ii) enriched vulnerability data for at least some of the one or more historical events;
determining, using the first set of feature values, that a vulnerability mitigation action is to be triggered for the first event; and
triggering performance of the vulnerability mitigation action for the first event.
